(19) United States
(12) Patent Application Publication
(10) Pub. No.: US 2026/0342194 A1
(43) Pub. Date: Oct. 29, 2026

(54) CIRCULAR CONVEYOR LINE

(71) Applicant: Shanghai Golytec Automation Co., Ltd., Shanghai (CN)

(72) Inventors: Feng CHI, Shanghai (CN); Zenghui CHEN, Shanghai (CN)

(21) Appl. No.: 19/189,465

(22) Filed: Apr. 25, 2025

(51) Int. Cl. H02K 41/03; B65G 54/02; H02K 11/21

(52) U.S. Cl. CPC H02K 41/031; B65G 54/02; H02K 11/21; B65G 2203/0283

(57) ABSTRACT

The present disclosure discloses a circular conveyor line, including a stator, a rotor, sensor arrays, a sensing element, and a plurality of controllers, where the stator includes a plurality of stator modules, each of which includes a base and a coil assembly; the coil assembly is mounted on an outer side surface of the corresponding base; a top side surface of each of the plurality of bases is provided with one sensor array; the plurality of sensor arrays are arranged in a circumferential direction of the stator to form a circle; a sensing element is arranged on the rotor; and the sensing element is located on a side of the sensor array facing away from the base, and is arranged opposite to and spaced apart from the sensor array in an axial direction of the stator.

### TECHNICAL FIELD

The present disclosure relates to the field of magnetic drive technologies, and in particular, to a circular conveyor line.

### BACKGROUND

Generally, a circular conveyor apparatus includes a circular stator and a rotor. The stator provides a driving force for movement of the rotor via magnetic drive.

In the related art, the position of the rotor is usually determined via measurement using a sensor array such as an optical grating or a magnetic grating. The optical grating or magnetic grating is usually arranged on a radial outer side of the circular stator. As a result, the circular conveyor apparatus occupies a relatively large radial space, leading to low space utilization.

### SUMMARY

Embodiments of the present disclosure provide a circular conveyor line, which can resolve the problem that the circular conveyor apparatus occupies a relatively large radial space.

An embodiment of the present disclosure provides a circular conveyor line, including a stator, a rotor, sensor arrays, a sensing element, and a plurality of controllers, where the stator includes a plurality of stator modules; the plurality of stator modules are connected serially, each of which includes a base and a coil assembly; the base has an inner side surface and an outer side surface in a radial direction of the stator and a top side surface and a bottom side surface in an axial direction of the stator; the coil assembly is mounted on the outer side surface of the corresponding base; the rotor is slidably connected to one of the plurality of bases; the rotor is provided with a permanent magnet array; the permanent magnet array is in magnetic fit with the coil assembly, so as to drive the rotor to move relative to the stator; the top side surface of each of the plurality of bases is provided with one of the plurality of sensor arrays; the plurality of sensor arrays are arranged in a circumferential direction of the stator to form a circle; the sensing element is arranged on the rotor; the sensing element is located on a side of the sensor array facing away from the base, and is arranged opposite to and spaced apart from the sensor array in the axial direction of the stator; each of the plurality of bases is internally provided with one of the plurality of controllers; and each of the plurality of controllers is electrically connected to the corresponding coil assembly and the corresponding sensor array. As the sensor arrays are arranged on the top side surfaces of the bases of the stator, dimensions of the coil assembly and the rotor in the radial direction can be designed smaller, thereby reducing a radial space occupied by the circular conveyor line.

In some embodiments, a projection of the sensor array in the axial direction of the stator is on a radial inner side of the corresponding coil assembly. In this way, the sensor array does not protrude from the base in the radial direction; and the sensing element and the sensor array are opposite to each other in the axial direction, and neither of them occupy any radial space of the circular conveyor line.

In some embodiments, channels are formed in the base; and electrical connections among the plurality of controllers, between the controllers and the corresponding sensor arrays, and between the controllers and the corresponding coil assemblies are all implemented by threading a power line and/or a signal line through the channels. The channels bundle the power line and/or the signal line and play a certain protective effect, thereby avoiding accidental breakage, electric leakage, and other hidden dangers caused when cables are connected and arranged in a mess and large areas of the cables are exposed to the outside.

In some embodiments, the stator modules include linear stator modules and arc-shaped stator modules; the base of the linear stator module is a linear base; the base of the arc-shaped stator module is an arc-shaped base; the outer side surface of the linear base is provided with a plug connector; the plug connector is provided with a power interface for plugging of the power line, and/or with a signal interface for plugging of the signal line; and the controller corresponding to the linear base is electrically connected to the controller corresponding to the adjacent arc-shaped base through the plug connector. Due to configuration of the plug connector, plug-in connection of a cable is facilitated.

In some embodiments, the channels formed in the linear base include a first channel, a second channel, and a third channel; the first channel connects the controller, the sensor array and the coil assembly disposed within the same linear base; the second channel connects the controller and the plug connector disposed within the same linear base; the third channel penetrates through the linear base in the radial direction of the stator, and forms a first cable port and a second cable port in the corresponding inner side surface and the corresponding outer side surface of the linear base, respectively; the channels formed in the arc-shaped base include a fourth channel, a fifth channel, and a sixth channel; the fourth channel connects the controller and the sensor array disposed within the same arc-shaped base, and forms a third cable port in the corresponding top side surface of the arc-shaped base; the fifth channel connects the controller and the coil assembly disposed within the same arc-shaped base, and forms a fourth cable port in the top side surface of the arc-shaped base; the sixth channel connects the controller in the arc-shaped base with an external space, and forms a fifth cable port in the corresponding inner side surface of the arc-shaped base; the controller is electrically connected to the sensor array and coil assembly disposed within the same linear base by threading the power line and/or the signal line through the first channel; the controller is electrically connected to the plug connector within the same linear base by threading the power line and/or the signal line through the second channel; the controller in the arc-shaped base is electrically connected to the sensor array by threading the power line and/or the signal line through the fourth channel and the third cable port; the controller in the arc-shaped base is electrically connected to the coil assembly by threading the power line and/or the signal line through the fifth channel and the fourth cable port; and the controller in the arc-shaped base is electrically connected to the plug connector to the adjacent linear base by threading the power line and/or the signal line through the sixth channel and the third channel and threading the power line and/or the signal line through the fifth cable port, the first cable port, and the second cable port sequentially.

In some embodiments, two linear stator modules and two arc-shaped stator modules are provided; the two linear bases and the two arc-shaped bases are connected alternately to form a circle; and each arc-shaped base is provided with two sixth channels, and each linear base is provided with two third channels, such that the controller corresponding to each linear base is connected in series, through the plug connector, to the controllers corresponding to the two adjacent arc-shaped bases.

In some embodiments, each of the plurality of bases includes an upper base and a lower base; the outer side surface of the lower base protrudes from the outer side surface of the upper base in the radial direction of the stator; the coil assembly is mounted on the outer side surface of the corresponding upper base; and both the plug connector and the second cable port are arranged on the outer side surface of the corresponding lower base.

In some embodiments, the rotor includes a base body and a connection plate; an accommodation groove is formed in a side of the base body facing the stator; the accommodation groove has two opposite side walls in the axial direction of the stator; the permanent magnet array is distributed on the two opposite side walls of the accommodation groove; the connection plate is mounted on a top side of the base body and extends towards the stator in the radial direction of the stator, such that a tail end of the connection plate is arranged opposite to the sensor array in the axial direction of the stator; and the sensing element is arranged at the tail end of the connection plate and faces the sensor array.

In some embodiments, a rail is convexly provided on the outer side surface of each of the plurality of bases; the plurality of rails are connected in the circumferential direction of the stator to form a circle; the base body is provided with a pulley; and the pulley is in sliding fit with the rails.

In some embodiments, the sensing element is an optical grating, and the sensor array is an optical grating read head; or the sensing element is a magnetic grating, and the sensor array is a magnetic grating read head; and the controller is configured to: obtain position information of the rotor by using the sensor array, and control, based on the obtained position information of the rotor and a preset target position of the rotor, a corresponding position of the coil assembly to energize or de-energize, thereby controlling the rotor to move or stop moving at the target position.

Based on the circular conveyor line according to the embodiments of the present disclosure, the sensor arrays are arranged on the top side surfaces of the bases of the stator. Therefore, compared with a manner in which sensor arrays enclose a radial outer side of a circular stator, the sensor arrays are convenient to mount, it is unnecessary to expand a radial space of the circular conveyor line for occupation, and the dimensions of the coil assembly and the rotor in the radial direction can be designed smaller, thereby reducing the radial space occupied by the circular conveyor line, and improving space utilization.

### BRIEF DESCRIPTION OF THE DRAWINGS

To describe technical solutions in embodiments of the present disclosure or in the prior art more clearly, the following briefly describes the accompanying drawings required for describing the embodiments or the prior art. Apparently, the accompanying drawings in the following description show merely some of the embodiments of the present disclosure, and those skilled in the art may still derive other drawings from these accompanying drawings without creative efforts.

FIG. 1 is a schematic diagram of a three-dimensional structure of a circular conveyor line in one direction according to an embodiment of the present disclosure;

FIG. 2 is a schematic diagram of a three-dimensional structure of the circular conveyor line in FIG. 1 in another direction;

FIG. 3 is a schematic diagram of a three-dimensional structure of the circular conveyor line in FIG. 1 in still another direction;

FIG. 4 is a schematic diagram of a three-dimensional structure of the circular conveyor line in FIG. 1 in yet another direction;

FIG. 5 is a schematic top view of the circular conveyor line in FIG. 1;

FIG. 6 is a schematic side view of the circular conveyor line in FIG. 1;

FIG. 7 is a schematic diagram of a three-dimensional structure of a linear stator module of a circular conveyor line according to an embodiment of the present disclosure; and

FIG. 8 is a schematic diagram of a three-dimensional structure of the linear stator module in FIG. 7 in another direction.

### REFERENCE NUMERALS OF COMPONENTS IN THE DRAWINGS ARE AS FOLLOWS

10: stator; 11: stator module; 11A: linear stator module; 11B: arc-shaped stator module; 111: base; 111A: linear base; 111B: arc-shaped base; 111a: inner side surface; 111b: outer side surface; 111c: top side surface; 111d: bottom side surface; 1111: upper base; 1112: lower base; 1113: first cable port; 1114: second cable port; 1115: third cable port; 1116: fourth cable port; 1117: fifth cable port; 1118: edge portion; 1119: step portion; 112: coil assembly; 113: rail; 20: rotor; 21: base body; 211: accommodation groove; 22: permanent magnet array; 23: connection plate; 24: pulley; 30: sensor array; 40: sensing element; 50: plug connector; 51: power interface; 52: signal interface; and 60: mounting platform.

### DETAILED DESCRIPTION

In order to make objectives, technical solutions and advantages of the present disclosure clearer, the following further describes the present disclosure in detail with reference to accompanying drawings and embodiments. It should be understood that the specific embodiments described herein are merely used to explain the present disclosure, rather than to limit the present disclosure. In description of the present invention, "a plurality of" means at least two, for example, two or three, unless otherwise clearly and specifically limited.

In addition, in the present invention, unless otherwise clearly specified and defined, terms ''connected'', "fixed", and the like should be understood in a broad sense. For example, unless otherwise clearly defined, a "connection" may be a fixed connection, a detachable connection, an integrated connection, a mechanical connection, an electrical connection, a direct connection, or an indirect connection through an intermediate medium, or may be an inner connection between two elements, or interaction between two elements. For those of ordinary skill in the art, specific meanings of the foregoing terms in the present invention may be understood based on specific situations.

In a creative design process of the present disclosure, inventors found that: in a circular conveyor apparatus, a function of positioning a rotor is generally implemented via induction fit between a sensor array and a sensing element, such as optical gratings, magnetic gratings, or the like; generally, sensor arrays enclose a radial outer side of a circular stator and are arranged below a coil assembly of the stator; on the basis that a magnetic fit structure between a coil assembly of a stator and a permanent magnet array of a rotor already occupies a specific radial space, increasing a length of the rotor in a radial direction is required for axially opposite fit between a sensing element on the rotor and a sensor array, which causes a radial width of the coil assembly to be designed relatively large; and the following design causes an entire radial dimension of a circular conveyor apparatus to become larger: a sensing element is provided at a portion on a radial inner side of a rotor and is matched with a sensor array, and a permanent magnet array is provided at a portion on a radial outer side of the rotor and is matched with a coil assembly. In addition, it is difficult to mount and fix a sensor array, and an electrical connection design is more complex. To resolve the technical problem that a circular conveyor apparatus in the related art occupies a relatively large radial space, embodiments of the present disclosure provide a circular conveyor line.

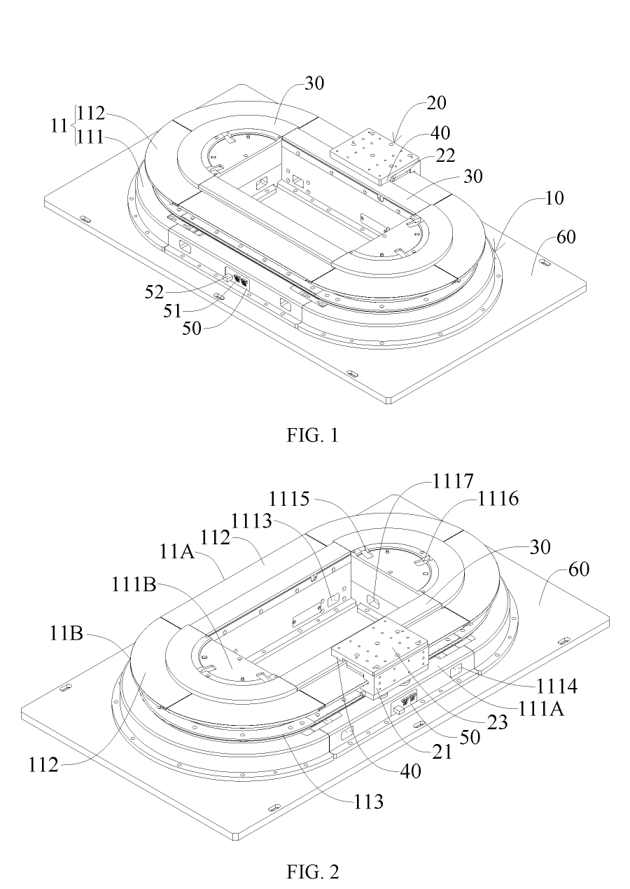

Referring to FIGS. 1 to 8, the circular conveyor line according to the embodiments of the present disclosure includes a stator 10, at least one rotor 20, sensor arrays 30, a sensing element 40, and controllers (not shown).

The stator 10 includes a plurality of stator modules 11. The plurality of stator modules 11 are connected sequentially into a circle. Each stator module 11 includes a base 111 and a coil assembly 112. The base 111 has an inner side surface 111a and an outer side surface 111b in a radial direction of the stator 10 and a top side surface 111c and a bottom side surface 111d in an axial direction of the stator 10. The coil assembly 112 is mounted on the outer side surface 111b of the corresponding base 111. The rotor 20 is slidably connected to the base 111. The rotor 20 is provided with a permanent magnet array 22. The permanent magnet array 22 is in magnetic fit with the coil assembly 112, so as to drive the rotor 20 to move relative to the stator 10. The top side surface 111c of each of the plurality of bases 111 is provided with one sensor array 30. The sensor arrays 30 are arranged in a circumferential direction of the stator 10 to form a circle. The sensing element 40 is arranged on the rotor 20. The sensing element 40 is located on a side of the sensor array 30 facing away from the base 111, and is arranged opposite to and spaced apart from the sensor array 30 in the axial direction of the stator 10. Each of the plurality of bases 111 is internally provided with one of the plurality of controllers. Each of the plurality of controllers is electrically connected to the corresponding coil assembly 112 and the corresponding sensor array 30.

In the foregoing structure, the base 111 is configured to carry the coil assembly 112 and the sensor array 30; and each of the plurality of controllers is electrically connected to the corresponding coil assembly 112 and the corresponding sensor array 30. The controller controls the coil assembly 112 to periodically energize, such that an armature winding of the coil assembly 112 generates a changing magnetic field. The magnetic field is used to magnetically cooperate with the permanent magnet array 22 on the rotor 20, so as to drive the rotor 20. The controller reads a position of the sensing element 40 sensed by the sensor array 30, thereby positioning the rotor 20. Cooperation between the sensor array 30 and the sensing element 40 may control a position and movement of the rotor 20, so as to convey a workpiece or material precisely. The circular conveyor line uses a circular line that is driven by magnetic power and transports workpieces, has a large transport capacity and high energy efficiency, and is suitable for transporting the workpieces or materials via long-term reciprocating movement.

Based on the circular conveyor line according to the embodiments of the present disclosure, the sensor arrays 30 are arranged on top side surfaces 111c of the bases 111 of the stator 10. Therefore, compared with a manner in which sensor arrays 30 enclose a radial outer side of a circular stator 10, the sensor arrays 30 are convenient to mount, it is unnecessary to expand a radial space of the circular conveyor line for occupation, and dimensions of the coil assembly 112 and the rotor 20 in the radial direction can be designed smaller, thereby reducing a radial space occupied by the circular conveyor line, improving space utilization, and reducing costs.

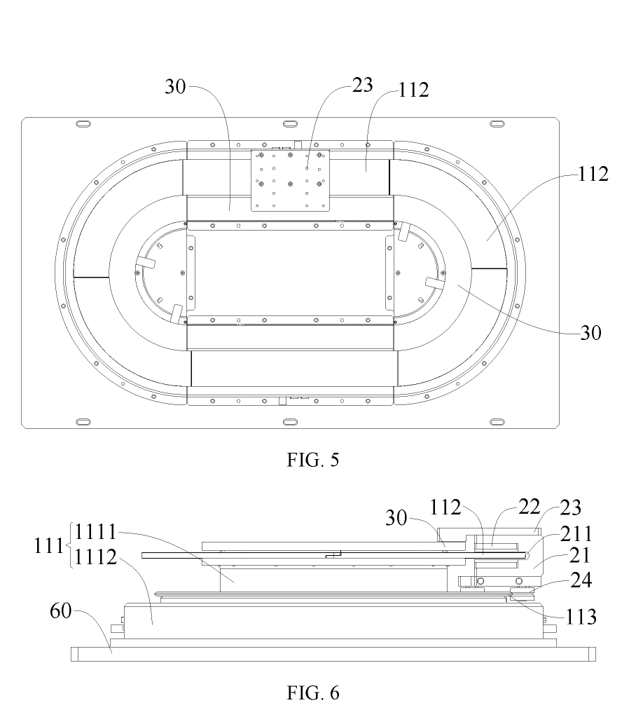

Further, referring to FIG. 5, a projection of the sensor array 30 in the axial direction of the stator 10 is on a radial inner side of the corresponding coil assembly 112, that is, an outer edge of the sensor array 30 in the radial direction is located within an outer edge of the base 111 or is flush with the outer edge of the base 111, such that the sensor array 30 does not protrude from the base 111 in the radial direction. Correspondingly, the sensing element 40 and the sensor array 30 on the rotor 20 are opposite to each other in the axial direction; the sensing element 40 and the sensor array 30 do not occupy any radial space of the circular conveyor line; and dimensions of the coil assembly 112 and the rotor 20 in the radial direction can be designed as small as possible. Therefore, a radial dimension of the circular conveyor line is reduced sufficiently.

In an embodiment of the present disclosure, the plurality of stator modules 11 may form the circular stator 10 via splicing. During splicing, the bases 111, the coil assemblies 112, and the sensor arrays 30 of two adjacent stator modules 11 are butted respectively, such that the spliced stator 10 can drive the rotor 20 to move continuously in the circumferential direction. It should be noted that a shape and a length of the stator module 11 are not limited. To help the rotor 20 move continuously and smoothly in the circumferential direction of the stator 10, each stator module 11 may be designed in various shapes such as a straight line or an arc. It is convenient for the rotor 20 to implement a steering operation on an arc-shaped stator module 11. Each type of the stator module 11 may be produced based on a standard length or dimension, which facilitates entire production, disassembly, and assembly of the stator 10. Based on a length of a travel by which the rotor 20 is required to move, different quantities of stator modules 11 can be selected and connected, so as to form a circular stator 10 having a required length. Moreover, to facilitate spliced use of different quantities and types of stator modules 11, the base 111 of each stator module 11 is internally provided with a controller, the controller may control or transmit a signal to the corresponding coil assembly 112 and the corresponding sensor array 30, and a plurality of controllers cooperate with each other, so as to control overall movement of the rotor 20.

To facilitate electrical connections of the controller with the corresponding coil assembly 112, the corresponding sensor array 30, and another controller, channels (not shown in the figure) are formed in the base 111. Electrical connections among the plurality of controllers, between the controllers and the corresponding coil assemblies 112, and between the controllers and the corresponding sensor arrays 30 are all implemented by threading a power line (not shown in the figure) and/or a signal line (not shown in the figure) through the channels. In this way, the channels bundle the power line and/or the signal line and play a certain protective effect, thereby avoiding accidental breakage, electric leakage, and other hidden dangers caused when cables are connected and arranged in a mess and large areas of the cables are exposed to the outside. Moreover, the entire structure is beautiful and aesthetically enduring.

Specifically, still referring to FIG. 2, the stator modules 11 may include linear stator modules 11A and arc-shaped stator modules 11B. The base 111 of the linear stator module 11A is a linear base 111A. Correspondingly, both the coil assembly 112 of the linear stator module 11A and the sensor array 30 mounted on the linear stator module 11A are linear. The base 111 of the arc-shaped stator module 11B is an arc-shaped base 111B. Correspondingly, both the coil assembly 112 of the arc-shaped stator module 11B and the sensor array 30 mounted on the arc-shaped stator module 11B are arc-shaped. After two linear bases 111A, or two arc-shaped bases 111B, or a linear base 111A and an arc-shaped base 111B are spliced, corresponding coil assemblies 112 and corresponding sensor arrays 30 may be spliced. Preferably, a material of the base 111 includes, but is not limited to, a profile, cast iron, an aluminum plate, or the like. Adjacent bases 111 may be fixed oppositely via bolting, or may be fixed oppositely via clamping, welding, gluing, or the like.

To facilitate plug-in connection of a cable, the outer side surface 111b of the base 111 is provided with a plug connector 50. The plug connector 50 is provided with a power interface 51 for plugging of the power line, and/or with a signal interface 52 for plugging of the signal line. The controller corresponding to the linear base 111A is electrically connected to the controller corresponding to the adjacent arc-shaped base 111B through the plug connector 50.

In some embodiments, there may be a plurality of linear stator modules 11A and a plurality of arc-shaped stator modules 11B. For example, the entire stator 10 may take a shape of a racetrack, which has two straight edges and two arc-shaped edges. Each straight edge may be one linear stator module 11A or may be formed by splicing a plurality of linear stator modules 11A together. Each arc-shaped edge may be one arc-shaped stator module 11B or may be formed by splicing a plurality of arc-shaped stator modules 11B together. For two adjacent linear stator modules 11A, the controller in each linear base 111A is electrically connected to the corresponding plug connector 50 by threading a cable through the channel; and electrical connections of the plug connectors 50 of the two linear bases 111A are implemented by plugging two ends of a cable into the plug connectors 50 respectively. Therefore, the controllers in the two adjacent linear bases 111A are connected in series. For two adjacent arc-shaped stator modules 11B, channels may be provided in the two arc-shaped bases 111B, and a series connection between controllers in the two arc-shaped bases 111B is implemented by threading a cable through the channels. For a linear stator module 11A and an arc-shaped stator module 11B that are adjacent to each other, one end of a cable is threaded through the channel in the arc-shaped base 111B and is connected to a controller in the arc-shaped base 111B, and the other end of the cable extends outwards and is plugged in the plug connector 50 of the linear base 111A, thereby implementing a series connection between the controllers in the linear stator module 11A and the arc-shaped stator module 11B that are adjacent to each other.

In addition, the plug connector 50 further plays a role in connecting an external power supply and/or signal source. The plug connector 50 may be provided with a plurality of power interfaces 51 thereon. One of the power interfaces 51 may provide a plug-in connection for a power line of an external power supply, so as to supply power to the coil assembly 112, the sensor array 30, and the controller. The remaining power interfaces 51 may each provide a plug-in connection for a power line, so as to implement a connection with the plug connector 50 on an adjacent linear base 111A or a connection with the controller in an adjacent arc-shaped base 111B. When there are a plurality of linear stator modules 11A, because the controllers in the various stator modules 11 are connected in series, power can be supplied to the entire stator 10, provided that the plug connector 50 of one of the linear bases 111A is in plug-in connection with an external power supply. Preferably, the plurality of power interfaces 51 may be configured with different voltage levels, so as to adapt to working environments of different places. For example, a voltage of an external power supply may be changed to ensure that an armature winding of the coil assembly 112 generates a magnetic field having a different strength. Because the rotor 20 has different moving speeds in magnetic fields having different strengths, a moving speed of the rotor 20 can be controlled in this way. Similarly, the plug connector 50 may be provided with a plurality of signal interfaces 52 thereon. One of the signal interfaces 52 is in plug-in connection with a signal line of an external signal source, so as to implement signal transmission between the external signal source and a controller or between controllers. Further, the power line may be a cable, a conducting wire, or the like; and the signal line may be an optical fiber. The power line and the signal line may be arranged separately, or may be integrated as a photoelectric hybrid cable. Correspondingly, the power interface 51 and the signal interface 52 may be arranged separately, or may be integrated as a hybrid interface, so as to implement a power supply function and a signal transmission function separately or simultaneously.

On routing of the power line and/or the signal line, more specifically, the channels (not shown) formed in the linear base 111A include a first channel, a second channel, and a third channel, and the channels (not shown) formed in the arc-shaped base 111B include a fourth channel, a fifth channel, and a sixth channel.

The first channel connects the controller in the linear base 111A with the sensor array 30, and connects the controller in the linear base 111A with the coil assembly 112. The controller is electrically connected to the sensor array 30 and the coil assembly 112 within the same linear base 111A by threading the power line and/or the signal line through the first channel. There may be two first channels. The two first channels spatially connect the controller in the linear base 111A with the sensor array 30, and connect the controller in the linear base 111A with the coil assembly 112, respectively. Alternatively, when points at which the sensor array 30 and the coil assembly 112 are in plug-in connection with cables are close to each other, there may be only one first channel, and the cables for connecting the sensor array 30, the coil assembly 112 and the controllers are threaded through the same first channel.

The second channel connects the controller in the linear base 111A with the plug connector 50. The controller in the linear base 111A is electrically connected to the plug connector 50 by threading the power line and/or the signal line through the second channel.

The fourth channel connects the controller and the sensor array 30 disposed within the same arc-shaped base, and forms a third cable port 1115 in the top side surface 111c of the arc-shaped base. The controller in the arc-shaped base 111B is electrically connected to the sensor array 30 by threading the power line and/or the signal line through the fourth channel and the third cable port 1115. The fifth channel connects the controller and the coil assembly 112 disposed within the same arc-shaped base 111B, and forms a fourth cable port 1116 in the top side surface 111c of the arc-shaped base. The controller in the arc-shaped base 111B is electrically connected to the coil assembly 112 by threading the power line and/or the signal line through the fifth channel and the fourth cable port 1116. Both the third cable port 1115 and the fourth cable port 1116 are formed in the top side surface 111c of the arc-shaped base 111B and both form openings extending to the outer side surface 111b. The sensor array 30 is mounted on the top side surface 111c of the arc-shaped base 111B, and is arranged close to an outer edge of the arc-shaped base 111B. The third cable port 1115 facilitates connecting a cable to a bottom side of the sensor array 30. The coil assembly 112 is mounted on the outer side surface 111b of the arc-shaped base 111B. The fourth cable port 1116 extends to an opening in the outer side surface 111b, which is beneficial to connecting a cable to a radial inner side of the coil assembly 112. Therefore, it is more convenient and faster to connect and maintain the cable.

The sixth channel connects the controller in the arc-shaped base 111B with an external space, and forms a fifth cable port 1117 in the inner side surface 111a of the arc-shaped base 111B. The third channel penetrates through the linear base 111A in the radial direction of the stator 10, and forms a first cable port 1113 and a second cable port 1114 in the inner side surface 111a and the outer side surface 111b respectively. The controller in the arc-shaped base 111B is electrically connected to the plug connector 50 corresponding to the adjacent linear base 111A by threading the power line and/or the signal line through the sixth channel and the third channel and threading the power line and/or the signal line through the fifth cable port 1117, the first cable port 1113, and the second cable port 1114 sequentially. In this way, during electrical connection between a linear stator module 11A and an arc-shaped stator module 11B that are adjacent to each other, a cable does not need to bypass an upper part or a lower part of the stator 10 for connection, so as to avoid a risk that the cable hinders movement of the rotor 20 or a risk that collision is increased. In addition, a length of the cable is designed to be shorter, such that costs are lower.

It should be noted that it is inappropriate to design a sectional dimension of each channel to be too small or too large. Specifically, the sectional dimension may be designed based on a quantity and thicknesses of cables to be threaded, provided that the cables can be threaded through the channel without excessive bending. Preferably, each channel is integrally formed in the base 111 in a production and casting process of the base 111, and subsequent independent perforating or mounting is not required, which is beneficial to production and mounting of the stator 10.

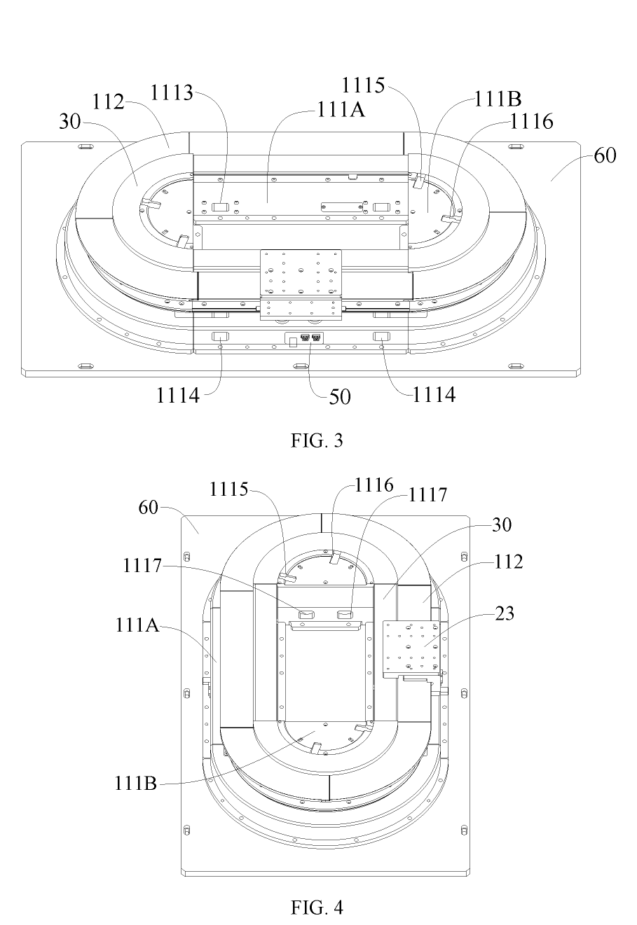

Referring to FIGS. 3 and 4, in embodiments shown in the drawings, two linear stator modules 11A and two arc-shaped stator modules 11B are provided. The two linear stator modules 11A are arranged opposite to each other. The two arc-shaped stator modules 11B are arranged opposite to each other. The linear stator modules 11A and the arc-shaped stator modules 11B are connected alternately to form a circle, that is, two ends of each linear stator module 11A are spliced with the arc-shaped stator modules 11B, and two ends of each arc-shaped stator module 11B are spliced with the linear stator modules 11A. The arc-shaped base 111B of the arc-shaped stator module 11B may be configured as a semi circle in its entirety. The arc-shaped base 111B has a planar inner side surface 111a and a curved outer side surface 111b. Two linear bases 111A are respectively spliced with two ends of the inner side surface 111a of the arc-shaped base 111B. Each arc-shaped base 111B is provided with two sixth channels, and each linear base 111A is provided with two third channels, such that the controller corresponding to each linear base 111A is connected in series, through the plug connector 50, to the controllers corresponding to the two adjacent arc-shaped bases 111B. Two fifth cable ports 1117 in the arc-shaped base 111B are respectively arranged close to the linear bases 111A on two sides. Two first cable ports 1113 and two second cable ports 1114 in the linear base 111A are respectively arranged close to the arc-shaped bases 111B on two sides, which is beneficial to smooth routing of a cable. Moreover, an exposed length of the cable in an inner space of the circular stator 10 is relatively short, and an occupied area is relatively small.

Further, referring to FIG. 6, each of the plurality of bases 111 includes an upper base 1111 and a lower base 1112. The lower base 1112 may be directly arranged on the ground or be mounted on a mounting platform 60, so as to provide a mounting foundation for the stator 10. The upper base 1111 may be arranged on the lower base 1112 via welding, bolting, integral forming, or the like. The outer side surface 111b of the lower base 1112 protrudes from the outer side surface 111b of the upper base 1111 in the radial direction of the stator 10, that is, a radial width of the lower base 1112 of the linear base 111A is greater than that of the upper base 1111, and a sectional radius of the lower base 1112 of the arc-shaped base 111B is greater than that of the upper base 1111, such that the lower base 1112 is supported or placed more stably. The coil assembly 112 is mounted on the outer side surface 111b of the corresponding upper base 1111. The upper base 1111 is smaller than the lower base 1112. As the coil assembly 112 is mounted on the upper base 1111, the radial dimension of the circular conveyor line can be further reduced on the basis that the stator 10 is supported and placed stably. Both the plug connector 50 and the second cable port 1114 are arranged on the outer side surface 111b of the corresponding lower base 1112, which prevents a cable from being routed too close to the coil assembly 112, so as to avoid interference with the rotor 20. A position of the fifth cable port 1117 is not limited, provided that the position corresponds to the inner side surface 111a of the upper base 1111 or the lower base 1112.

Still referring to FIG. 6, in an embodiment of the present disclosure, the rotor 20 includes a base body 21 and a connection plate 23. An accommodation groove 211 is concavely formed in a side of the base body 21 facing the stator 10. The accommodation groove 211 has two opposite side walls in the axial direction of the stator 10. The accommodation groove 211 extends in the circumferential direction of the stator 10 and penetrates through two ends of the base body 21. The permanent magnet array 22 is distributed on the two opposite side walls of the accommodation groove 211. Preferably, the permanent magnet array 22 includes a plurality of permanent magnets that may be arranged in a Halbach array, so as to obtain a relatively optimal unilateral magnetic field, thereby improving a driving force of the circular conveyor line. A groove opening is formed in a side of the accommodation groove 211 facing the stator 10. The coil assembly 112 passes through the groove opening of the accommodation groove 211 and is arranged between the permanent magnet arrays 22 on the two opposite side walls of the accommodation groove 211. When the armature winding of the coil assembly 112 is energized, a magnetic field is generated. Under current excitation, the permanent magnet array 22 generates a driving force that can propel the rotor 20 to move. A specific operating principle of a magnetic propulsion rail has long been disclosed in the related art, and thus is not described again in the present disclosure.

The connection plate 23 is mounted on a top side of the base body 21 and extends towards the stator 10 in the radial direction of the stator 10, such that a tail end of the connection plate 23 is arranged opposite to the sensor array 30 in the axial direction of the stator 10; and the sensing element 40 is arranged at the tail end of the connection plate 23 and faces the sensor array 30. In this way, the sensing element 40 is arranged opposite to and spaced apart from the sensor array 30 in the axial direction of the stator 10; both of the sensing element 40 and the sensor array 30 do not occupy any radial space of the circular conveyor line; and a signal emitted by the sensing element 40 can be read by the sensor array 30, so as to monitor and control a moving position of the rotor 20.

Further, a rail 113 is convexly provided on the outer side surface 111b of each of the plurality of bases 111; the plurality of rails 113 are connected in the circumferential direction of the stator 10 to form a circle; the base body 21 is provided with a pulley 24; and the pulley 24 is in sliding fit with the rails 113, so as to restrict a moving direction of the rotor 20. Preferably, the rail 113 is arranged on the outer side surface 111b of the upper base 1111. The pulley 24 is arranged on a bottom side of the base body 21. The pulley 24 may be a wheel-shaped structure having a groove. As the groove of the pulley 24 is clamped and in sliding fit with the rail 113 to implement movement of the pulley 24 on the rail, the rotor 20 is prevented, in a moving process, from deviating relative to the stator 10 in the axial direction of the stator 10. Certainly, in other embodiments, the pulley 24 and the rail 113 may be replaced with a combination of a slider and a rail or a combination of balls and a rail; and both of the combinations can restrict the moving direction of the rotor 20.

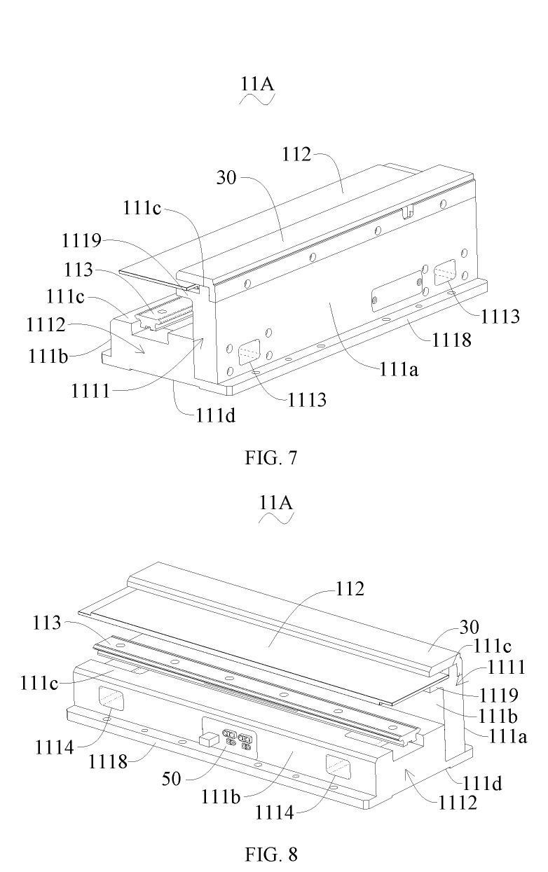

More specifically, in embodiments of the present disclosure, a structure of the stator 10 is further described by using the linear stator module 11A as an example. Referring to FIGS. 7 and 8, in an embodiment, the upper base 1111 may be of a rectangular plate-shaped structure that is arranged vertically; the lower base 1112 may be of a rectangular plate-shaped structure that is arranged horizontally; edge portions 1118 are convexly provided on two radial sides of the lower base 1112, namely, bottoms of the inner side surface 111a and the outer side surface 111b of the lower base 1112; bolt holes may be formed in the edge portions 1118, which is beneficial to fixing the entire base 111 on the mounting platform 60 using bolts; and the upper base 1111 may be fixed on the inner side surface 111a of the lower base 1112 via welding, bolting, or the like. Both the plug connector 50 and the second cable port 1114 are arranged on the outer side surface 111b of the lower base 1112; the first cable port 1113 is arranged on the inner side surface 111a of the upper base 1111; and the third channel penetrates through the upper base 1111 and the lower base 1112 in the radial direction of the stator 10. It should be noted that a manner in which the sensor array 30, the coil assembly 112, and the rail 113 are connected to the base 111 is not limited. For example, the sensor array 30 may be fixed on the top side surface 111c of the upper base 1111 via bolting, gluing, or the like; a junction between the outer side surface 111b and the top side surface 111c of the upper base 1111 may be provided with a step portion 1119 protruding from the outer side surface 111b and recessed in the top side surface 111c; the coil assembly 112 may be fixed on the step portion 1119 via bolting, gluing, or the like; the step portion 1119 supports and fixes the coil assembly 112; and the rail 113 may be fixed on the outer side surface 111b of the upper base 1111 or the top side surface 111c of the lower base 1112 via welding, gluing, bolting, or the like, provided that the rail is in sliding fit with the pulley 24 of the base body 21.

In some embodiments, the sensing element 40 may be an optical grating, and the sensor array 30 may correspondingly be an optical grating read head; or the sensing element 40 may be a magnetic grating, and the sensor array 30 may correspondingly be a magnetic grating read head. To control the moving position of the rotor 20 precisely, the controller is configured to: obtain position information of the rotor 20 by using the sensor array 30, and control, based on the obtained position information of the rotor 20 and a preset target position of the rotor 20, a corresponding position of the coil assembly 112 to energize or de-energize, thereby controlling the rotor 20 to move or stop moving at the target position. Specifically, when the rotor 20 moves in the circumferential direction of the stator 10, the sensing element 40 passes through an encoder array, and the encoder array may obtain position information of the rotor 20 in real time and transfer the position information to the controller. The plurality of controllers are connected in series. Each controller may control an energized status of the corresponding coil assembly 112. Based on the preset target position of the rotor 20, the controller may pre-determine an armature winding area of the coil assembly 112 to which the rotor 20 is about to move and cover, and may pre-energize an armature winding that is to be run by the rotor 20. An excitation magnetic field generated by the armature winding interacts with a permanent magnetic field generated by the permanent magnet array 22 of the rotor 20 to form a pushing force, causing the rotor 20 to move translationally. When the rotor 20 is about to reach the target position, the controller controls the armature winding of the coil assembly 112 at the target position to de-energize, such that the rotor 20 stops moving upon reaching the target position. When there are a plurality of rotors 20, the controller controls each rotor 20 independently, that is, each rotor 20 moves independently of the other rotors 20, such that movement of the plurality of rotors 20 is controlled precisely.

In the accompanying drawings of the embodiments, the same or similar reference numerals denote the same or similar components. In the description of the present disclosure, it should be understood that if there is an orientation or positional relationship indicated by terms "top", "bottom", "inner", "outer", or the like, the orientation or positional relationship is based on the accompanying drawings. These terms are merely used to facilitate description of the present disclosure and simplify the description, rather than to indicate or imply that the mentioned apparatus or element necessarily have a specific orientation or be constructed and operated in a specific orientation. Therefore, the terms describing the positional relationships in the accompanying drawings are only used for illustrative purposes and should not be construed as a limitation to the present patent. A person of ordinary skill in the art may interpret the specific meaning of the above terms according to specific conditions.

The foregoing descriptions are merely preferred embodiments of the present disclosure, but are not intended to limit the present disclosure. Any modifications, equivalent replacements, improvements, and the like made without departing from the spirit and principle of the present disclosure shall fall within the protection scope of the present disclosure.

What is claimed is:

1. A circular conveyor line, comprising:
a stator, comprising a plurality of stator modules, wherein the plurality of stator modules are connected serially; each stator module comprises a base and a coil assembly; the base has an inner side surface and an outer side surface in a radial direction of the stator and a top side surface and a bottom side surface in an axial direction of the stator; and the coil assembly is mounted on the outer side surface of the corresponding base;
a rotor slidably connected to one of the plurality of bases, wherein the rotor is provided with a permanent magnet array; and the permanent magnet array is in magnetic fit with the coil assembly, so as to drive the rotor to move relative to the stator;
a plurality of sensor arrays arranged in a circumferential direction of the stator to form a circle, wherein the top side surface of each of the plurality of bases is provided with one of the plurality of sensor arrays;
a sensing element arranged on the rotor, wherein the sensing element is located on a side of the sensor array facing away from the base, and is arranged opposite to and spaced apart from the sensor array in the axial direction of the stator; and
a plurality of controllers, wherein each of the plurality of bases is internally provided with one of the plurality of controllers; and each of the plurality of controllers is electrically connected to the corresponding coil assembly and the corresponding sensor array.

2. The circular conveyor line according to claim 1, wherein a projection of the sensor array in the axial direction of the stator is on a radial inner side of the corresponding coil assembly.

3. The circular conveyor line according to claim 2, wherein channels are formed in the base; and electrical connections among the plurality of controllers, between the controllers and the corresponding sensor arrays, and between the controllers and the corresponding coil assemblies are all implemented by threading a power line and/or a signal line through the channels.

4. The circular conveyor line according to claim 3, wherein the stator modules comprise linear stator modules and arc-shaped stator modules; the base of the linear stator module is a linear base; and the base of the arc-shaped stator module is an arc-shaped base; and
the outer side surface of the linear base is provided with a plug connector; the plug connector is provided with a power interface for plugging of the power line, and/or with a signal interface for plugging of the signal line; and the controller corresponding to the linear base is electrically connected to the controller corresponding to the adjacent arc-shaped base through the plug connector.

5. The circular conveyor line according to claim 4, wherein the channels formed in the linear base comprise a first channel, a second channel, and a third channel; the first channel connects the controller, the sensor array and the coil assembly disposed within the same linear base; the second channel connects the controller and the plug connector disposed within the same linear base; and the third channel penetrates through the linear base in the radial direction of the stator, and forms a first cable port and a second cable port in the corresponding inner side surface and the corresponding outer side surface of the linear base, respectively;
the channels formed in the arc-shaped base comprise a fourth channel, a fifth channel, and a sixth channel; the fourth channel connects the controller and the sensor array disposed within the same arc-shaped base, and forms a third cable port in the corresponding top side surface of the arc-shaped base; the fifth channel connects the controller and the coil assembly disposed within the same arc-shaped base, and forms a fourth cable port in the top side surface of the arc-shaped base; and the sixth channel connects the controller in the arc-shaped base with an external space, and forms a fifth cable port in the corresponding inner side surface of the arc-shaped base; and
the controller is electrically connected to the sensor array and coil assembly within the same linear base by threading the power line and/or the signal line through the first channel; the controller is electrically connected to the plug connector within the same linear base by threading the power line and/or the signal line through the second channel; the controller in the arc-shaped base is electrically connected to the sensor array by threading the power line and/or the signal line through the fourth channel and the third cable port; the controller in the arc-shaped base is electrically connected to the coil assembly by threading the power line and/or the signal line through the fifth channel and the fourth cable port; and the controller in the arc-shaped base is electrically connected to the plug connector to the adjacent linear base by threading the power line and/or the signal line through the sixth channel and the third channel and threading the power line and/or the signal line through the fifth cable port, the first cable port, and the second cable port sequentially.

6. The circular conveyor line according to claim 5, wherein two linear stator modules and two arc-shaped stator modules are provided; and the two linear bases and the two arc-shaped bases are connected alternately to form a circle; and
each arc-shaped base is provided with two sixth channels, and each linear base is provided with two third channels, such that the controller corresponding to each linear base is connected in series, through the plug connector, to the controllers corresponding to the two adjacent arc-shaped bases.

7. The circular conveyor line according to claim 5, wherein each of the plurality of bases comprises an upper base and a lower base; and the outer side surface of the lower base protrudes from the outer side surface of the upper base in the radial direction of the stator; and
the coil assembly is mounted on the outer side surface of the corresponding upper base; and both the plug connector and the second cable port are arranged on the outer side surface of the corresponding lower base.

8. The circular conveyor line according to claim 2, wherein the rotor comprises a base body and a connection plate; an accommodation groove is formed in a side of the base body facing the stator; the accommodation groove has two opposite side walls in the axial direction of the stator; the permanent magnet array is distributed on the two opposite side walls of the accommodation groove; the connection plate is mounted on a top side of the base body and extends towards the stator in the radial direction of the stator, such that a tail end of the connection plate is arranged opposite to the sensor array in the axial direction of the stator; and the sensing element is arranged at the tail end of the connection plate and faces the sensor array.

9. The circular conveyor line according to claim 8, wherein a rail is convexly provided on the outer side surface of each of the plurality of bases; the plurality of rails are connected in the circumferential direction of the stator to form a circle; the base body is provided with a pulley; and the pulley is in sliding fit with the rails.

10. The circular conveyor line according to claim 1, wherein the sensing element is an optical grating, and the sensor array is an optical grating read head; or the sensing element is a magnetic grating, and the sensor array is a magnetic grating read head; and
the controller is configured to: obtain position information of the rotor by using the sensor array, and control, based on the obtained position information of the rotor and a preset target position of the rotor, a corresponding position of the coil assembly to energize or de-energize, thereby controlling the rotor to move or stop moving at the target position.
